(19) United States
(12) Patent Application Publication
(10) Pub. No.: US 2026/0284529 A1
(43) Pub. Date: Sep. 24, 2026

(54) NON-TRANSITORY COMPUTER-READABLE STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Mario M. VELARDE, Austin, TX (US); Jordan C. JOHNSON, Austin, TX (US); Jonathan L. WOFFORD, Austin, TX (US); Jose M. GUERRA CHAPA, Austin, TX (US); Joseph J. CHERLIN, Austin, TX (US)

(21) Appl. No.: 19/085,754

(22) Filed: Mar. 20, 2025

(51) Int. Cl. A63F 13/5255; A63F 13/5258

(52) U.S. Cl. CPC A63F 13/5255; A63F 13/5258

(57) ABSTRACT

The game device (10) has an indicator control unit (215) that displays an indicator in a fixed position overlapping with an object when an indicator fixed type object placed in the virtual space is in the aiming direction, and displays the indicator in a position moving according to the aiming direction within the overlap range with the object when an indicator-following type object located in the virtual space is in the aiming direction, and when the indicator is displayed, changes the direction of the virtual camera and the aiming direction toward the indicator in response to the operation input.

### FIELD

The present disclosure relates to information processing systems, information processing apparatuses, and information processing methods that perform information processing related to virtual spaces.

### BACKGROUND AND SUMMARY

A system is known that sets a virtual camera in a virtual space, target objects in the virtual space, and executes actions such as shooting and investigating on the targeted objects (see JP2011-255119A, for example).

### Configuration 1

A computer-readable non-transitory storage medium according to an aspect, has stored therein instructions to be executed by one or more processors of an information processing apparatuses, the instructions causing the one or more processors to:
in a first scene,
control a direction of a virtual camera in a virtual space based on a directional input;
control an aiming direction in the virtual space based on a directional input;
display an indicator at a first position that overlaps an object of a first type when the object of the first type located in the virtual space is in the aiming direction;
display an indicator at a second position that is moved in accordance with the aiming direction within an range at least overlapping with an object of a second type that is placed in the virtual space and is different from the object of the first type when the object of the second type is in the aiming direction; and
direct the direction of the virtual camera and the aiming direction to the indicator in response to an operation input when the indicator is displayed.

This configuration can improve the user experience by providing different control for the first type of object and the second type of object.

### Configuration 2

In the non-transitory computer readable storage medium of configuration 1, the instructions may cause the one or more processors to control the direction of the virtual camera and the aiming direction to match based on the same directional input.

### Configuration 3

In the non-transitory computer-readable storage medium of Configuration 1 or 2, the instructions may further cause the one or more processors to: display an aiming cursor indicating the aiming direction; and display the indicator when the aiming direction is directed at the object of the first type or the object of the second type.

This configuration makes it easier for the player to visually confirm which object is in the aiming direction.

### Configuration 4

In the non-transitory computer readable storage medium of any of Configurations 1-3, the object of the second type may be larger than the object of the first type.

This configuration allows the position at which the indicator is displayed for a relatively large object to be moved in accordance with the aiming direction, thereby suppressing sudden fluctuations in orientation that may occur when the direction of the virtual camera and the aiming direction are directed toward the indicator.

### Configuration 5

In the non-transitory computer readable storage medium of any of Configurations 1-4, the instruction may further cause the one or more processors to display an explanatory UI associated with the object corresponding to the indicator in response to the operational input.

With this configuration, the explanation UI for the object can be displayed with the virtual camera and aiming direction facing the object, so it is clear which object the explanation UI is for, improving the user experience.

### Configuration 6

In the non-transitory computer readable storage medium of any of Configurations 1-5, the instruction may further cause the one or more processors to: move a player character within the virtual space based on a directional input; and control a position of the virtual camera according to a position of the player character within the virtual space.

This configuration can improve the user experience in games where the virtual camera is controlled by multiple different means.

### Configuration 7

In the non-transitory computer readable storage medium of any of Configurations 1-6, the instruction may cause the one or more processors to:
in a second scene different from the first scene,
restrict the direction of the virtual camera in the virtual space;
control the aiming direction in the virtual space based on a directional input; and
display an indicator at a first position that overlaps an object of a first type when the object of the first type located in the virtual space is in the aiming direction;
display an indicator at a second position that is moved in accordance with the aiming direction within an range at least overlapping with an object of a second type that is placed in the virtual space and is different from the object of the first type when the object of the second type is in the aiming direction;
direct the direction of the virtual camera and the aiming direction to the indicator in response to an operation input when the indicator is displayed.

This configuration can improve the user experience even in cases where the control of the orientation of the virtual camera is restricted, when the control of the virtual camera differs depending on the scene.

### Configuration 8

The information processing system in an aspect has one or more processors and a memory coupled thereto, wherein the one or more processors are configured to control the information processing system to perform at least:
in a first scene,
controlling a direction of a virtual camera in a virtual space based on a directional input;
controlling an aiming direction in the virtual space based on a directional input;
displaying an indicator at a first position that overlaps an object of a first type when the object of the first type located in the virtual space is in the aiming direction;
displaying an indicator at a second position that is moved in accordance with the aiming direction within an range at least overlapping with an object of a second type that is placed in the virtual space and is different from the object of the first type when the object of the second type is in the aiming direction; and
directing the direction of the virtual camera and the aiming direction to the indicator in response to an operation input when the indicator is displayed.

### Configuration 9

An information processing apparatus in an aspect comprises one or more processors and a memory coupled thereto, wherein the one or more processors are configured to control the information processing apparatus to perform at least:
in a first scene,
controlling a direction of a virtual camera in a virtual space based on a directional input;
controlling an aiming direction in the virtual space based on a directional input;
displaying an indicator at a first position that overlaps an object of a first type when the object of the first type located in the virtual space is in the aiming direction;
displaying an indicator at a second position that is moved in accordance with the aiming direction within an range at least overlapping with an object of a second type that is placed in the virtual space and is different from the object of the first type when the object of the second type is in the aiming direction; and
directing the direction of the virtual camera and the aiming direction to the indicator in response to an operation input when the indicator is displayed.

### Configuration 110

An information processing method in an aspect is an information processing method executed using one or more processors, the information processing method comprising:
in a first scene,
controlling a direction of a virtual camera in a virtual space based on a directional input;
controlling an aiming direction in the virtual space based on a directional input;
displaying an indicator at a first position that overlaps an object of a first type when the object of the first type located in the virtual space is in the aiming direction;
displaying an indicator at a second position that is moved in accordance with the aiming direction within an range at least overlapping with an object of a second type that is placed in the virtual space and is different from the object of the first type when the object of the second type is in the aiming direction; and
directing the direction of the virtual camera and the aiming direction to the indicator in response to an operation input when the indicator is displayed.

### BRIEF DESCRIPTION OF DRAWINGS

FIG. 1 shows the appearance of the game device of the information processing system of an embodiment;

FIG. 2 is a block diagram showing the configuration of the information processing apparatus of an embodiment;

FIG. 3A shows an example of a game screen of the embodiment;

FIG. 3B shows an example of a game screen of the embodiment;

FIG. 4 shows a file that records information on scannable objects of the embodiment;

FIG. 5A shows an example of a game screen of the embodiment;

FIG. 5B shows an example of a game screen of the embodiment;

FIG. 5C shows an example of a game screen of the embodiment;

FIG. 5D shows an example of a game screen of the embodiment;

FIG. 6A shows an example of a game screen of the embodiment;

FIG. 6B shows an example of a game screen of the embodiment;

FIG. 7A shows an example of a game screen of the embodiment;

FIG. 7B shows an example of a game screen of the embodiment;

FIG. 8 shows an example of a game screen of the embodiment;

FIG. 9A is a flowchart showing the information processing method of the embodiment; and

FIG. 9B is a flowchart showing the indicator control of the embodiment.

### EMBODIMENTS OF THE DISCLOSURE

The information processing system and information processing program of the embodiment are described below with reference to the drawings. The following description is only an example of a preferred embodiment and is not intended to limit the invention described in the claims.

The following describes embodiments of an information processing system, etc., in which a virtual camera is installed in a virtual space to improve the user experience when aiming at an object and performing actions on the object.

The following describes an example of scanning, or investigating, an object that has been targeted as an action, but actions other than scanning may be performed on the object. For example, the action may be an attack, an interaction, or a lock-on action.

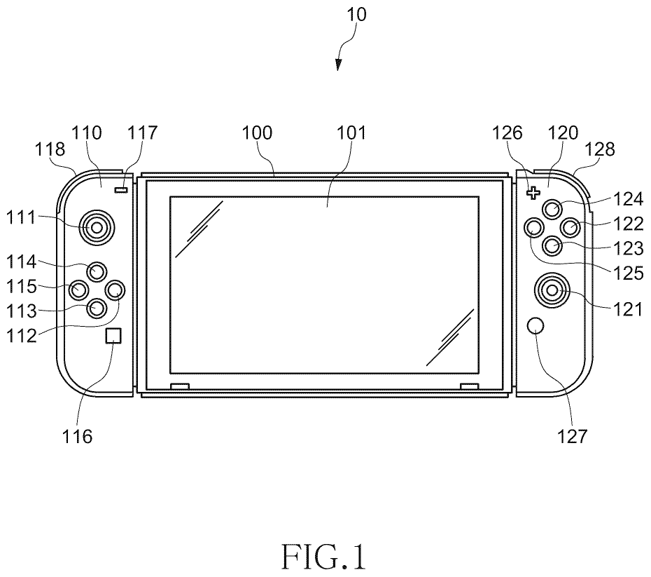

FIG. 1 shows the appearance of the game device of the information processing system of an embodiment. In this embodiment, the information processing apparatus is configured as a game device 10 that executes a game as information processing. In this embodiment, the information processing device is a game device as a dedicated device for playing games, but instead of this, a game device 10 may be configured by a general-purpose computer, such as a smartphone, tablet computer, laptop computer, or desktop computer, executing a game program.

The game device 10 in this embodiment includes a game device main unit 100 equipped with a touch panel display 101, a left controller 110, and a right controller 120. The left controller 110 and the right controller 120 can be attached to and detached from the main body 100 of the game device. In other words, the game device 10 can be used as an integrated device with the left controller 110 and the right controller 120 attached to the game device main body 100. In addition, the game device 10 may be used with the game device main body 100 and the left controller 110 and the right controller 120 as separate units.

The left controller 110 is equipped with an analog stick 111 for inputting directions and four operation buttons (specifically, a right direction button 112, a down direction button 113, an upward direction button 114, and a left direction button 115) as operation members to be operated by the user. In addition, the left controller 110 is equipped with a recording button 116, a − (minus) button 117, and an L button 118 as the operation members to be operated by the user.

Like the left controller 110, the right controller 120 is equipped with an analog stick 121 for inputting directions and four operation buttons (specifically, the A button 122, B button 123, X button 124, and Y button 125) as the operation members. In addition, the right controller 120 is also equipped with a + (plus) button 126, a home button 127, and an R button 128 as the operation members.

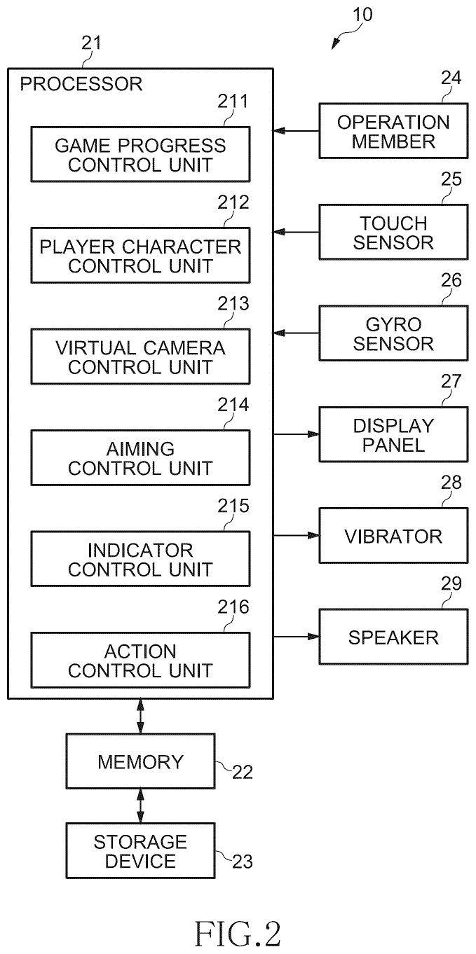

FIG. 2 is a block diagram showing the configuration of the information processing apparatus of an embodiment. As described above, the information processing device in this embodiment is configured as a game device 10. The game device 10 is equipped with a computer system comprising a processor 21, a memory 22, and a storage device 23. The processor 21, as an arithmetic processor, loads the game program as an information processing program stored in the memory device 23 into the memory 22 and executes the game program. The game device 10 may have one processor 21 that performs all necessary operations and controls, or it may have multiple processors 21, including a processor that performs general operations and controls and a processor that performs graphics processing and the like.

The storage device 23 may be built into the game device 10 or may be a portable storage device that is removable from the game device 10 as a non-transitory computer readable medium. In the case where the storage device 23 is built into the game device 10, the game program may be downloaded to the game device 10 via a communication network and stored in the storage device 23. The portable device may be a cartridge, and the game device 10 may have a structure to mount the cartridge.

The game device 10 has an operation member 24, a touch sensor 25, and a gyro sensor 26 as configurations for inputting user operations. The game device 10 also has a display panel 27, a vibrator 28, and a speaker 29 as configurations for outputting the results of information processing by the processor 21. A touch panel display 110 shown in FIG. 1 is configured by the display panel 27 and the touch sensor 25. The operation members 24 are the analog sticks 111, 121, and operation buttons 112, 122, etc. shown in FIG. 1.

The touch sensor 25 detects touch by a capacitive method, a resistive method, or other methods and outputs an electrical signal. The gyro sensor 26, as a type of inertial sensor, is provided in left controller 110 and right controller 120, respectively, and detects changes in rotation or orientation of the left controller 110 and the right controller 120 as angular velocity using Coriolis force and outputs electrical signals. The left controller 110 and right controller 120 may be provided with other inertial sensors, such as acceleration sensors, instead of or in addition to the gyro sensor 26. The gyro sensor 26 and other inertial sensors may be provided in the main unit 100 of the game device.

The display panel 27 displays the results of information processing by the processor 21. The game device 10 as an information processing device in this embodiment displays a game screen. Display panel 27 displays an image of the subjective viewpoint of the player character in the virtual space during game execution. The vibrators 28 are provided on the left controller 110 and the right controller 120 and vibrate in response to information processing by the processor 21. The speaker 29 is provided on the main unit 100 of the game device and output sound in response to information processing by the processor 21.

As described above, the operation member 24, the touch sensor 25, and the gyro sensor 26 all accept operation input by the player and can be collectively referred to as input devices. In addition, the display panel 27, the vibrator 28, and the speaker 29 all output visual, tactile, and audio information, respectively, in response to information processing by the processor 21, and can be collectively referred to as output devices.

The input device may be, for example, a mouse used for a general-purpose computer. A voice recognition system that recognizes speech by inputting the user's voice, or an image recognition system that recognizes images by capturing the user's gestures may also be used as an input device.

The game executed in this embodiment is described below. The game described below is only one example, and the present disclosure is applicable to games with other specifications. The processor 21 has a game progress control unit 211, a player character control unit 212, a virtual camera control unit 213, an aiming control unit 214, an indicator control unit 215, and an action control unit 216 to execute the game. As described above, these units of the processor 21 are realized by the processor 21 executing the game program, and can be referred to as functions provided by the processor 21 executing the game program, or as functional modules of the game program.

In this embodiment, the game progress control unit 211 provides a game in which a player manipulates a player character in a virtual space to accomplish a mission. Objects such as the ground, structures, objects, and enemy characters are set in the virtual space. In addition, a virtual camera is set up in the virtual space. The virtual camera captures images from the subjective viewpoint of the player character in the virtual space. The image captured by the virtual camera is displayed on the display panel 27. The screen displayed on the display panel 27 during a game is hereinafter referred to as a game screen.

In this embodiment, a first-person shooter (FPS) game is provided in which the game screen displays images from the subjective viewpoint. In FPS games, the player character is basically not displayed on the game screen, however, parts of the player character's arms and hands, as well as the weapons held in the hands, may be displayed on the game screen.

In this game, the player character can switch between shooting mode, in which the player character shoots with the weapon he/she is holding, and scanning mode, in which the player character scans objects in the virtual space. Specifically, the game progress control unit 211 switches modes in response to the pressing of the X button 124. The modes are not limited to these, and the shooting mode and scanning mode are examples only. For example, instead of, or in addition to, the shooting mode, there may be a movement mode in which movement is performed.

The game screen displays an aiming cursor superimposed on the image of the virtual space from the subjective viewpoint captured by the virtual camera. The aiming cursor is aligned with the player character's line of sight (i.e., the direction of the virtual camera). Therefore, the aiming cursor is displayed in the center of the game screen. The aiming cursor is used to indicate the shooting direction in the shooting mode and to identify which scannable object is to be scanned in the scanning mode.

In the virtual space, scannable objects that can be scanned in the scanning mode are placed. The scannable objects may be highlighted, for example, when captured by the virtual camera. In this embodiment, the scannable object is highlighted by changing its color. Changing the color is, for example, changing the texture to a predetermined color.

The player character control unit 212 controls the movement and rotation (i.e., direction change) of the player character in the virtual space. Specifically, the player character control unit 212 moves the player character in the virtual space in response to the directional input to the analog stick 111 of the left controller 110 and rotates the player character in response to the directional input to the analog stick 121 of the right controller 120. The player character control unit 212 also causes the player character to perform actions in response to button operations. For example, the player character is made to jump, fly, operate weapons, or scan objects as described below.

The virtual camera control unit 213 controls the movement and rotation of the virtual camera in the virtual space. Specifically, the virtual camera control unit 213 moves the virtual camera within the virtual space in response to directional input to the analog stick 111 of the left controller 110, and rotates the virtual camera in response to directional input to the analog stick 121 of the right controller 120. In other words, as described above, the virtual camera captures the image from the subjective viewpoint, that is, the viewpoint of the player character, so the virtual camera also moves within the virtual space and rotates within the virtual space as the player character moves and rotates.

The aiming control unit 214 controls the aiming direction with respect to the player character. Specifically, the aiming control unit 214 changes the aiming direction according to the directional input to the analog stick 121 of the right controller 120. As described above, in this embodiment, the aiming cursor coincides with the player character's line of sight, i.e., the direction in which the virtual camera is shooting (hereinafter simply referred to as the “virtual camera direction”). Therefore, as the player character rotates, the aiming direction is also changed to be aligned with the player character's line of sight. The aiming control unit 214 displays an aiming cursor indicating the aiming direction on the game screen superimposed on the captured image of the virtual space.

As described above, in this embodiment, the player character's line of sight direction, the direction of the virtual camera, and the aiming direction are aligned. Therefore, the player character and the virtual camera move according to the directional input to the analog stick 111 of the left controller 110, and the player character's line of sight direction, virtual camera direction, and aiming direction are changed according to the directional input to the analog stick 112 of the right controller 120. In other words, in this embodiment, the player character and the virtual camera move according to the same directional input, and the player character's line of sight direction, virtual camera direction, and aiming direction are changed according to the same directional input.

The directional input is not limited to input to the analog stick 111 of the left controller 110 and the analog stick 121 of the right controller 120. Some or all of the player control unit 212, the virtual camera control unit 213, and the aiming control unit 214 may control the movement and rotation of the player characters, the movement and rotation of the virtual camera, and the change of the aiming direction by using inputs to other operating members 24, inputs to the touch sensor 25, or the sensing value of the gyro sensor 26 as directional inputs, respectively. Furthermore, in this embodiment, the operation members assigned to the operation inputs or directional inputs assigned to each operation are all examples and are not limited to these.

In this embodiment, the virtual camera captures images from the subjective viewpoint, but alternatively, the virtual camera may be installed above the player character's back in the virtual space to capture images from the third-person viewpoint. In this case, control of the player character's movement and/or rotation and control of the virtual camera's movement and/or rotation may be performed independently. In other words, the directional input for the movement and/or rotation of the player character and the directional input for the movement and/or rotation of the virtual camera may be performed by separate input devices.

Similarly, the aiming direction may be changed independently of the player character's line of sight direction and/or the direction of the virtual camera. That is, the directional input for changing the aiming direction and the directional input for changing the player character's line of sight direction may be performed by separate input devices and/or the directional input for changing the aiming direction and the direction of the virtual camera may be performed by separate input devices. Alternatively, under certain conditions, the aiming direction may be changeable, with the player character and/or the virtual camera fixed (see below for details).

The indicator control unit 215 controls indicators to be displayed on the game screen. When a scannable object placed in the virtual space is in the aiming direction, that is, when the scannable object overlaps with the aiming cursor on the game screen, the indicator control unit 215 displays an indicator at a position that overlaps with the scannable object. By displaying this indicator, the player can confirm that the sight is aligned with the object on which the indicator is displayed. Specifically, in the scanning mode, the indicator control unit 215 displays the indicator in the overlapping position with the scannable object when the scannable object located in the virtual space is in the aiming direction.

The action control unit 216 performs a action on the object on which the indicator is superimposed by the indicator control unit 215, in response to an operation input. Specifically, in the scanning mode, when the L button 118 is pressed while there is a scannable object in the aiming direction and the indicator is superimposed on the scannable object, the action control unit 216 executes a scan on the scannable object. In this embodiment, the position where the indicator is displayed is the position where the scan is executed. The position at which the scan is performed, i.e., the position at which the indicator is displayed, is also called the scan point.

When an operation input is made to execute a scan, the aiming cursor moves to the scan point, and then the scan is started. As described above, the aiming cursor faces the direction of the player's line of sight, i.e., the direction of the virtual camera, so the virtual camera actually rotates so that it faces the scan point when the operation input to execute the scan is given, and then the scan is executed.

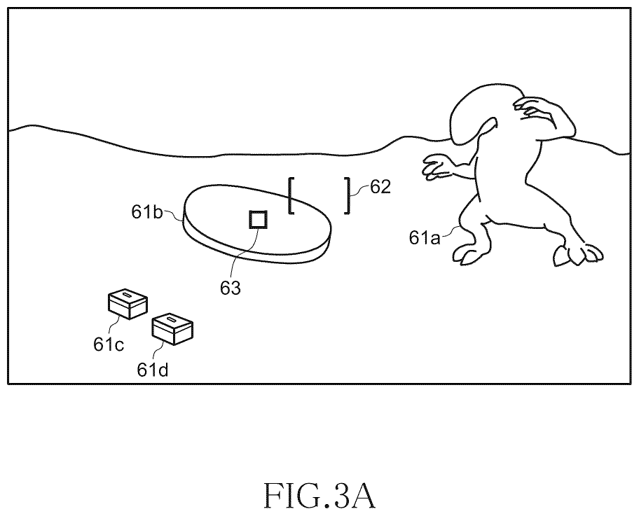

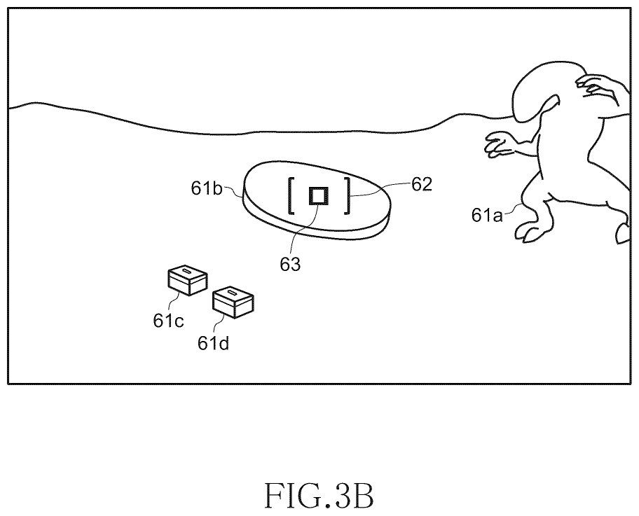

FIGS. 3A and 3B shows an example of a game screen of the embodiment. In the virtual space captured in the game screen in FIG. 3A, there is enemy character object 61a and item objects 61b, 61c, and 61d. The enemy character object 61a and item objects 61b, 61c, and 61d are all scannable objects. An aiming cursor 62 is displayed in the center of the game screen. In the example in FIG. 3A, the item object 61b is the scannable object in the aiming direction, and the aiming cursor 62 overlaps the item object 61b on the game screen, so a scan point 63 is displayed in the center of the item object 61b.

In this embodiment, the aiming cursor 62 is a combination of a left bracket and a right bracket, and the area within the brackets is the area that is being aimed. Thus, in this embodiment, the aimed area is an area with a predetermined size. In this embodiment, if an object is even partially included in this bracketed area, the object is judged to be aimed. The form of the aiming cursor 62 is not limited to this. The aiming cursor 62 may be represented by a dot, for example.

In this embodiment, the scan point 63 is displayed superimposed on the image of the virtual space when rendering the game screen, but instead, the scan point 63 may be placed within the virtual space, and the image of the virtual space with such a scan point 63 placed therein may be captured by a virtual camera and displayed as a game screen. In this case, the scan point 63 may be positioned on the scannable object or between the virtual camera and the scannable object.

In this embodiment, the scan point 63 is displayed for a single scannable object that the aiming cursor 62 is aligned with, but instead, the scan point 63 may be displayed for multiple scannable objects within the game screen. In this case, the action control unit 216 may execute scanning of a scannable object that satisfies certain conditions among the scannable objects for which the scan points 63 are displayed, in response to an operation input for instructing scanning.

When multiple scannable objects are displayed in the game screen and a scan instruction is received, for example, the action control unit 216 may select a scannable object corresponding to the scan point 63 closest to the aiming cursor to execute the scan. Alternatively, the action control unit 216 may select a scannable object with the highest evaluation value to execute the scan. In this case, the scan point 63 of the selected scannable object may be highlighted. Alternatively, when multiple scannable objects are displayed in the game screen and a scan instruction is received, the action control unit 216 may execute the scan of those multiple scannable objects simultaneously or sequentially.

When the L button 118 is pressed while the scan point 63 is displayed, indicating that scanning is to be performed, the virtual camera rotates so that it faces the scan point 63 in the center of the game screen, as shown in FIG. 3B. As a result, as shown in FIG. 3B, the aiming cursor 62 and the scan point 63 overlap. This allows the player to clearly understand which scannable object is being instructed to be scanned and executed.

Here, if the scannable object is large, the position of the aiming cursor 62, i.e., the distance between the direction of the virtual camera and the scan point 63, may be far apart at the time the scan is indicated, and if the scan is instructed in such a state, the virtual camera will suddenly make a large rotation. Such a sudden change in the game screen may degrade the player's user experience.

Therefore, for some scannable objects, the indicator control unit 215 dynamically controls the position of the scan point 63 to follow the aiming cursor 62 in order to prevent sudden changes in the game screen at the start of scanning as described above. In other words, multiple scannable objects are located in the virtual space, and these scannable objects can be divided into two types in terms of the manner in which the scan points are displayed.

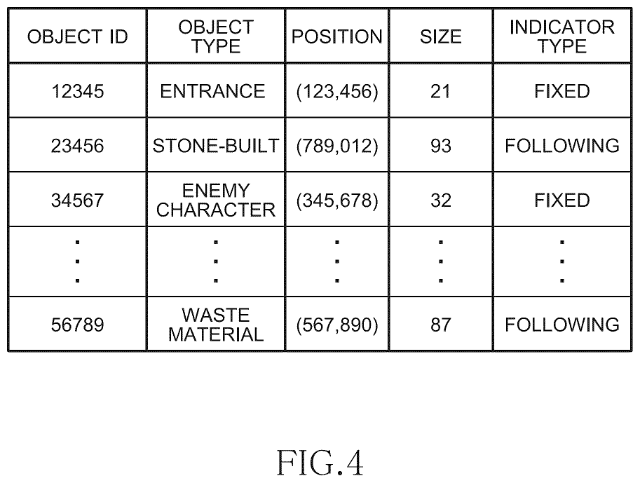

FIG. 4 shows a file that records information on scannable objects of the embodiment. This data is stored in the storage device 23 together with the game program, read from storage device 23 to memory 22, and referenced by the indicator control unit 215. The data includes, for each scannable object, an object ID to uniquely identify the object, an object type indicating the type of object, the position of the object in the virtual space, the size of the object in the virtual space, and information of the indicator type of the object.

A method other than using the above data may be used to obtain the indicator type or to control the indicator for an object in the virtual space. For example, the indicator control unit 215 may control the indicator based on the image captured by the virtual camera without referring to the data recording the information of the scannable object. For example, such control may be performed only in cases where the control of the indicator by the indicator control unit 215 under certain conditions is different for the same object, as described below.

The indicator types include the indicator fixed type (“fixed” in FIG. 4), in which the scan point 63 is fixed in the center of the scannable object, as shown in FIGS. 3A and 3B, and the indicator following type (“following” in FIG. 4), in which the scan point 63 follows the aiming cursor 62, as explained below.

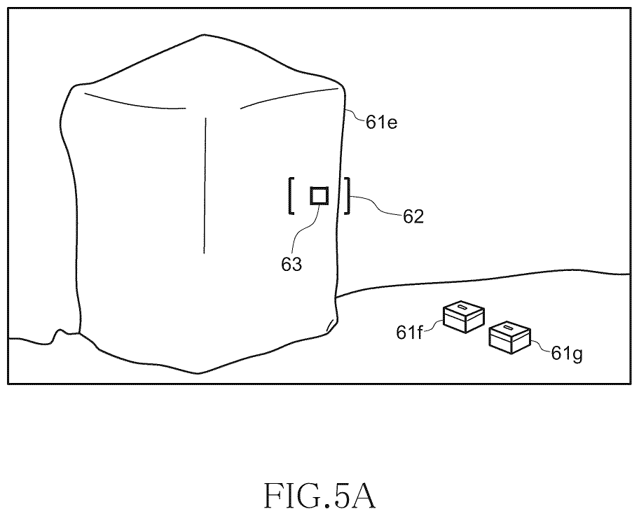

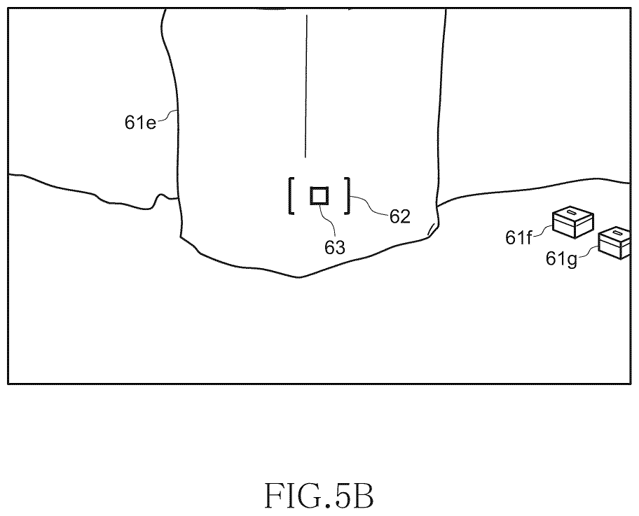

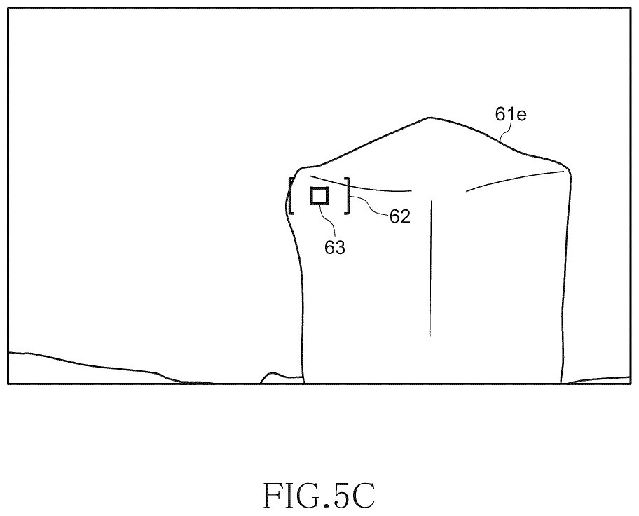

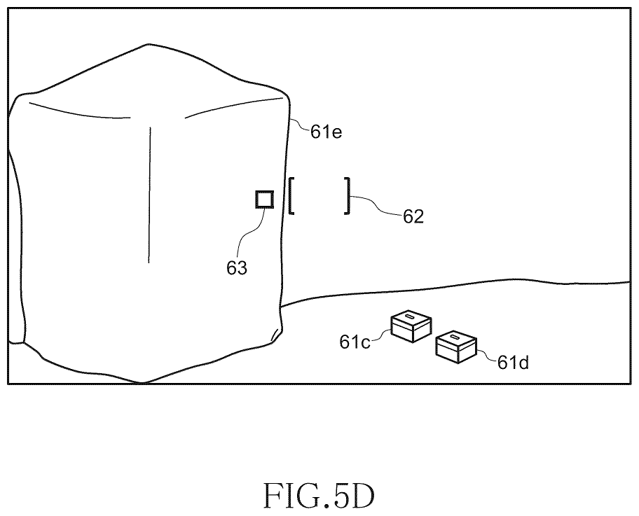

FIGS. 5A to 5D shows an example of a game screen of the embodiment. In the example of FIG. 5A, there is a relatively large scannable object 61e and relatively small scannable objects 61f and 61g in the game screen. In this example, scannable object 61e is an indicator following type scannable object, and the scannable objects 61f and 61g are indicator fixed type scannable objects.

As shown in FIG. 5A, the scan point 63 is displayed at a position overlapping the aiming cursor 62. FIGS. 5B and 5C show the aiming cursor 62 moved. In both FIGS. 5B and 5C, the aiming cursor 62 is aligned with the scannable object 61e, and the scan point 63 is displayed at the position of the aiming cursor 62.

The scan point 63 can follow the aiming cursor 62 and move to any point on the scannable object 61e. In other words, the indicator control unit 215 moves the scan point 63 on the scannable object so that it overlaps the aiming cursor 62 as long as the aiming cursor 62 is aligned with the scannable object 61e.

In this embodiment, when the scannable object is of the indicator following type, the scan point 63 can follow the aiming cursor 62 and move to any position on the scannable object. Alternatively, the indicator control unit 215 may, for example, move the scan point 63 so that it overlaps the aiming cursor 62 only within a partial area of the scannable object (e.g., a partial area in the center). In this case, the indicator control unit 215 may move the scan point 63 within the partial region to be closest to the aiming cursor 62 if the aiming cursor 62 is outside the partial region and on the scannable object.

If the indicator control unit 215 moves the aiming cursor 62 slightly off the scannable object 61e as shown in FIG. 5D from the state as shown in FIGS. 5A to 5C where the aiming cursor 62 is aligned with the scannable object 61e, it may not immediately make the scan point 63 disappear, but the display of scan point 63 may be maintained within a certain limit.

The above certain limit may be, for example, distance or time. That is, the indicator control unit 215 may cause the display of the scan point 63 to disappear when the aiming cursor 62 is more than a predetermined distance away from the edge of the indicator following type scannable object 61e, or, the indicator control unit 215 may cause the display of the scan point 63 to disappear after a predetermined time has elapsed after the aiming cursor 62 has left the indicator following type scannable object 61e.

In this embodiment, the scan points of the scannable object of the indicator fixed type and the scannable object of the indicator following type are displayed in the same manner (square marks), but the scan points may be displayed in a different manner for the indicator fixed type and the indicator following type. For example, the scan point of the indicator following type may be displayed in a different shape, color, size, and/or animation than the scan point of the indicator fixed type.

Whether each of a plurality of scannable objects placed in the virtual space should be of the indicator fixed type or the indicator following type can first be determined by the size of the scannable objects. In other words, scannable objects smaller than a predetermined size may be set as the indicator fixed type, and scannable objects larger than a predetermined size may be set as the indicator following type.

In addition, an object that moves within the virtual space may be set as an indicator following type. Also, if there are multiple areas on the scannable object that are assigned differently in some way, such scannable object may be set as an indicator following type. Here, different assignments means that different processing is performed depending on the location of the aiming, for example, different messages appear, etc.

The indicator following type may also be used for scannable objects where the player character can stand on top of the scannable object or go under the bottom of the scannable object. This is because if the scan point 63 is fixed in the center of the scannable object when viewed from the front, and the player character starts scanning the scannable object while being on top of or under the bottom of the scannable object, if the virtual camera is moved so that the scan point 63 is in the direction of the virtual camera, the camera will move violently off-screen, which will degrade the user experience.

The indicator following type may also be used for scannable objects where visibility is poor if the scan point 63 is displayed in the center. For example, a scannable object with a concave, protruding, or hollow center may be of the indicator following type.

In the case where some action different from scanning is possible when the aiming cursor 62 is aligned with the center portion, and an indication of the action is displayed, if the indication and the scan point 63 may overlap resulting in difficulty in operating the action, the scannable object may also be of the indicator following type.

In addition, if there are a plurality of different scannable objects in close proximity and the aiming cursor is displayed in the center of each, it may be difficult to tell which scannable object is the target of the scan execution, i.e., the scannable object may appear as if another object is selected depending on the angle. These scannable objects, or in other words, the scannable objects that are difficult to decide which one is the target of scanning may also be set as an indicator following type.

Furthermore, a scannable object that is composed of multiple non-adjacent objects may also be of the indicator following type. For example, if there are multiple piles of rubble composed of many stones, and these piles are regarded as one scan object, focusing on any one of the piles or the midpoint between the piles would be unnatural. Therefore, these multiple piles can be regarded as a single scannable object of an indicator following type.

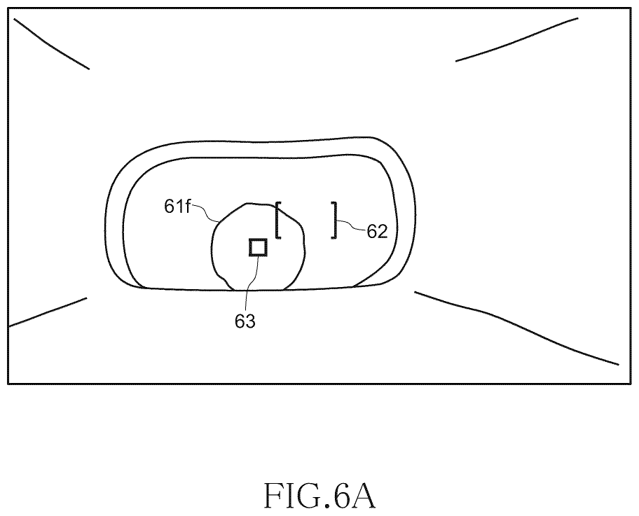

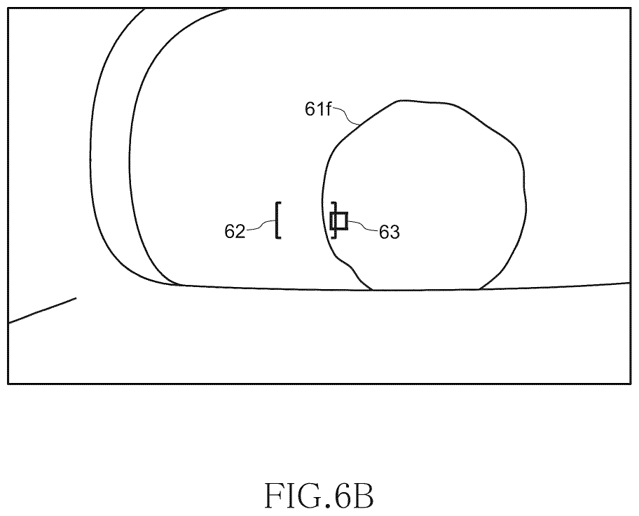

FIGS. 6A and 6B show yet another example of indicator type determination. Instead of fixedly setting the scannable object as an indicator fixed type or an indicator following type, the indicator control unit 215 may dynamically switch between having the indicator be fixed or having the indicator follow the aiming cursor 62 based on certain conditions.

Specifically, when the scannable object is displayed on the game screen at a predetermined size or larger, the scannable object may be set as an indicator following type, and when the scannable object is displayed on the game screen at a predetermined size or smaller, the scannable object may be set as an indicator fixed type.

In FIGS. 6A and 6B, an entrance is displayed on the game screen as a scannable object 61f. If the scannable object 61f is located relatively far from the virtual camera, the scannable object 61f is displayed relatively small on the game screen, as shown in FIG. 6A. In this case, the indicator control unit 215 sets the scannable object 61f as an indicator fixed type and displays the scan point 63 in the center of the scannable object 61f when the aiming cursor 62 is aligned with the scannable object 61f.

On the other hand, when the scannable object 61f is relatively close to the virtual camera, the scannable object 61f is displayed relatively large on the game screen, as shown in FIG. 6B. In this case, the indicator control unit 215 sets the scannable object 61f as an indicator following type, and when the aiming cursor 62 is aligned with the scannable object 61f, the scan point 63 follows the aiming cursor 62 so that it overlaps the aiming cursor 62. The scan point 63 is made to follow the aiming cursor 62 so that it overlaps the aiming cursor 62.

In this way, the indicator control unit 215 may dynamically switch whether to make the indicator be fixed or follow based not only on the size of the scannable object in the virtual space, but also on its positional relationship with the virtual camera or its size displayed in the game screen.

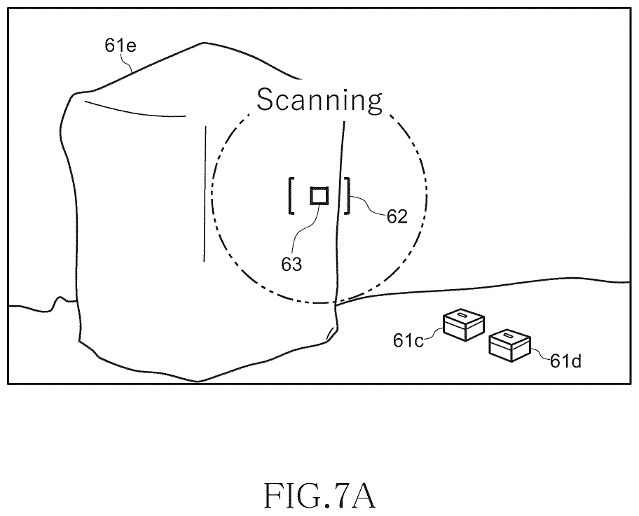

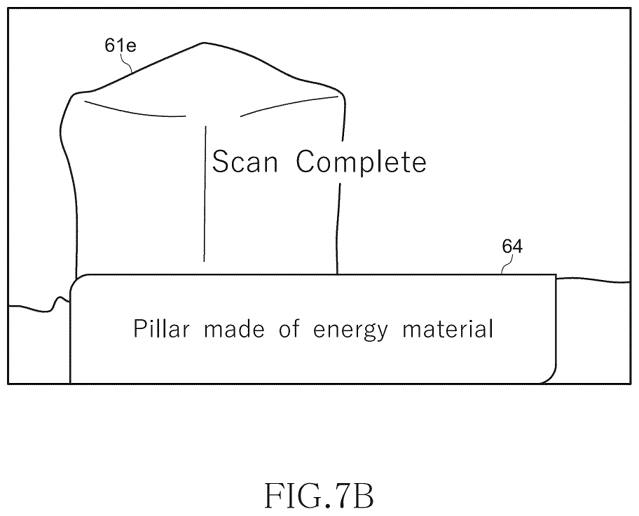

FIGS. 7A and 7B show examples of a game screen of the embodiment. When scanning is instructed by pressing the L button 118 while the scan point 63 is displayed on the scannable object, the action control unit 216 starts scanning the scannable object as an action for that object.

FIG. 7A shows the game screen when scanning is initiated. As described above, when scanning is instructed, the game screen is generated with the virtual camera facing the scan point 63. If the scannable object is of the indicator fixed type, and if the aiming cursor 62 (i.e., the direction of the virtual camera) and the scan point 63 are misaligned when the scan is indicated, the virtual camera will rotate until the direction of the virtual camera is aligned with the scan point 63.

On the other hand, if the scannable object is an indicator following type, basically, the scan point 63 moves to overlap with the aiming cursor 62 following the aiming cursor 62's movements (i.e., the changing direction of the virtual camera), so that at the time the scan is indicated, the aiming cursor 62 and the scan point 63 overlap, and no rotation of the virtual camera occurs as a result of the scan being instructed.

However, as shown in FIG. 5D, if the aiming cursor 62 and the scan point 63 are slightly displaced for an indicator following type scannable object, the action control unit 216 rotates the virtual camera so that the aiming cursor 62 is slightly moved to the position of the scan point 63 in response to the instruction to start scanning.

Thus, in this embodiment, when scanning is instructed, the action control unit 216 performs a series of processes to align the direction of the virtual camera and the aiming direction with the scan point and then starts scanning, but instead of this, the action control unit 216, in response to the initial scanning instruction, may align the direction of the virtual camera and the aiming direction with the scan point, and then the scan may be performed in response to the second scan instruction. In this case, the operation input for the first scan instruction and the operation input for the second scan instruction may be the same or different from each other. In this case, if the direction of the virtual camera and the aiming direction have been already aligned with the scan point when the first scan instruction is given, scanning may be started immediately by the first scan instruction.

In this embodiment, the aiming direction always faces the direction of the virtual camera and thus the aiming cursor is fixed at the center of the game screen. However, when controlling the direction of the virtual camera and the aiming direction to automatically face the scan point in response to a scan instruction, only the direction of the virtual camera may face the scan point first, and the aiming direction may lag behind it and follow the rotation of the virtual camera direction to face the scan point. Or, conversely, only the aiming direction may be oriented toward the scan point first, and the direction of the virtual camera may lag behind it, following the rotation of the aiming direction.

When the scan is initiated, as shown in FIG. 7A, the game screen displays a guide indicating that the scan is being executed. After the scan is started, the progress of the scan is performed by pressing and holding the L button 118, which is the button to start the scan. Alternatively, after the scan is started, the scan may progress automatically without any user action. Also, the scanning may be interrupted while the scanning is in progress by events such as interruption of the holding of the button, disappearance of the scannable object, or the player character executing the scan being attacked by an enemy character. Not limited to these, for example, the success or interruption of the scan may be determined based on the value of a random number generated at the start of the scan. If the scan is interrupted, the scanning mode may be automatically switched to another mode. The interruption herein also includes failure.

If the scan is successful, as shown in FIG. 7B, information explaining the scannable object that was scanned is displayed in text in a dialog 64 as an explanatory user interface (UI) associated with the scannable object, along with a notification that the scan Was successful. In this embodiment, the information explaining the scanned object is displayed with the direction of the virtual camera and the aiming direction facing the scanned object, so it is easy to understand which scannable object the explanation is for.

If the scan is interrupted, the dialog 64 does not have to be displayed. Alternatively, a dialog 64 indicating that the scan was interrupted may be displayed. The process performed upon a successful scan is not limited to displaying the dialog. For example, it may be the playback of a certain sound, the addition of a certain parameter, etc. It may also be a combination of these. In the case where an action that is not a scan is performed, for example, when an attack is performed, the processing performed upon a successful attack may be the addition of damage to the enemy character or the destruction of the enemy character.

In this embodiment, the game progress control unit 211 stops the game progress in the virtual space when the dialog 64 is displayed and a predetermined time has elapsed since the dialog 64 was displayed. This allows the player to read the explanation displayed in the displayed dialog 64 without worrying about the progress of the game, e.g., that the player character will be attacked by an enemy character while reading.

The action control unit 216 may clear the dialog 64 from the game screen in response to an operation input by the player, may automatically clear the dialog 64 from the game screen after a predetermined time elapses, or may clear the dialog 64 when an operation input is made by the player within a predetermined time period and clear the dialog 64 after a predetermined time period has elapsed when the operation input is made by the player within a predetermined time period. The game progress control unit 211 restarts the game progress when the dialog 64 is cleared.

In this embodiment, the aiming direction is basically fixed to the direction of the virtual camera and thus the aiming cursor 62 is fixed to the center of the game screen, but by satisfying certain conditions, the virtual camera can be fixed and only the aiming direction can be moved. In other words, in the scanning mode, when there is no aiming cursor 62 on the scannable object and thus no scan point 63 is displayed, the virtual camera is fixed when the operation to instruct scanning, i.e., pressing the L button 118, is performed. At this time, when the analog stick 111 of the right controller 110 is operated, the aiming control unit 214 moves the aiming cursor 62 in the game screen according to the tilt of the analog stick 111.

By configuring the system to limit the rotation of the virtual camera based on user operation when the scan point 63 is not displayed, and to move only the aiming direction based on directional input, the player can use a means appropriate to the situation to align the aiming direction with the object. For example, when continuously aligning the aiming direction between objects located at a distance, the player's user experience can be improved by fixing the direction of the virtual camera in a position that includes both objects and moving only the aiming direction in response to directional input.

The situation in which the aiming cursor 62 moves in conjunction with the direction of the virtual camera as in the above embodiment is defined as the first scene, and the situation in which the aiming cursor 62 can be moved independently of the direction of the virtual camera when the aiming cursor 62 is not on the scannable object and the scanning instruction is given is defined as the second scene. In addition to the above example, the condition to become the second scene may be set according to, for example, the progress of the game.

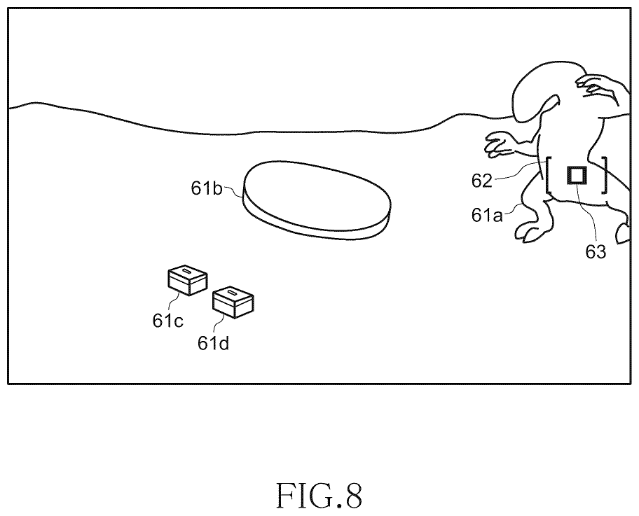

FIG. 8 shows an example of a game screen of the embodiment. FIG. 8 shows an example of a game screen for the second scene. In the example in FIG. 8, the virtual camera is oriented toward the scannable object 61b, but the aiming cursor 62 is aligned with the scannable object 61a on the right side of the game screen, and thus the scan point 63 is also overlapped with the scannable object 61a.

In the second scene, the virtual camera control unit 213 does not change the direction of the virtual camera, but the player character control unit 212 controls the movement of the player character in response to the directional input, so the virtual camera also moves or rotates accordingly. Therefore, the movement of the virtual camera itself is not restricted in the second scene. Instead, at least one of the movement and rotation of the virtual camera may be completely restricted.

Conversely, the direction of the virtual camera may be controlled so that it is not completely fixed, for example, the virtual camera control unit 213 may control the virtual camera so that it is more difficult to move or rotate than usual, or it may impose restrictions such that the virtual camera cannot be moved by directional inputs but can be moved by other operational inputs. For example, when the aiming cursor 62 is moved independently of the virtual camera, and the aiming cursor 62 comes to the edge of the game screen and is instructed to move further out of the game screen, the virtual camera control unit 213 may move or rotate the virtual camera in conjunction with the aiming cursor 62.

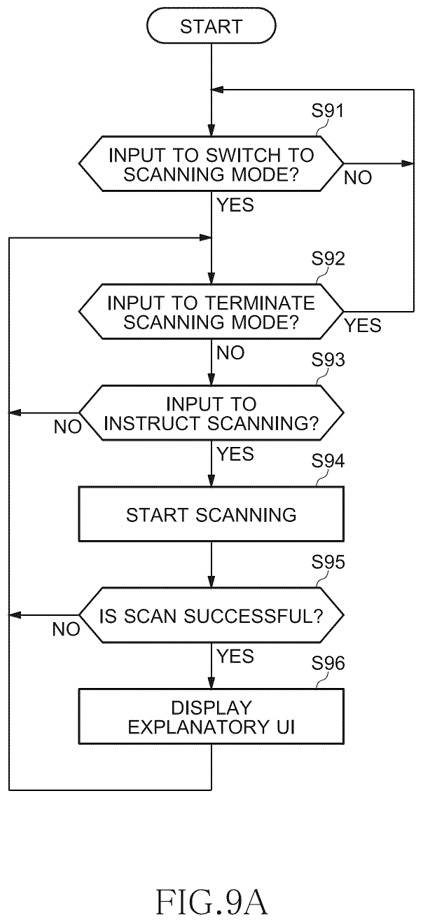

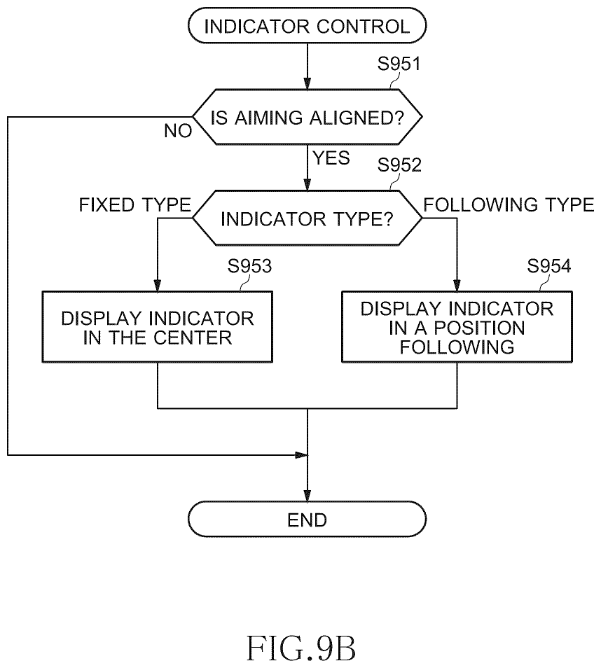

FIG. 9A is a flowchart showing an example of the information processing method of the embodiment. The processes described in this embodiment may include other processes or may not include some processes. Also, the order of execution of each process is an example; for example, multiple processes may be executed in parallel, and some processes may be executed in the reverse order of the description. For convenience of explanation, the processes are divided into units of steps, but these units of division are arbitrary, and multiple steps may be integrated, or a single step may be divided into multiple steps. The same applies to the explanations thereafter.

In this embodiment, game processing is performed as information processing using a game device. First, the game progress control unit 211 determines whether a switching input from the shooting mode, which is the default mode, to the scanning mode, which is the non-default mode, has been made (step S91). If it is determined that a switching input has been made (YES in step S91), the mode is switched to the scanning mode, which enables scanning. If it is not determined that a switching input was made (NO in step S91), it does not switch to the scanning mode and returns to the state of determining whether a scanning mode switching input was made again. For example, this step may be omitted in cases where scanning is possible in the shooting mode. When in scanning mode, the following process is performed.

In scanning mode, the virtual camera control unit 213 and the aiming control unit 214 wait for a directional input to the analog sticks 111 and 121. If a directional input is received, the virtual camera control unit 213 controls the virtual camera to move and/or rotate according to the directional input, and the aiming control unit 214 controls the aiming direction to change according to the directional input. In the scanning mode, the indicator control unit 215 controls the scan point 63 as an indicator.

FIG. 9B is a flowchart of indicator control. The indicator control unit 215 first determines whether the aiming is aligned with the scannable object (step S951). If the aiming is aligned with the scannable object (YES in step S951), the indicator is to be displayed, but before that, it is determined whether the scannable object is an indicator fixed type or indicator following type (step S952).

If the scannable object that is being aimed is of the indicator fixed type (“fixed type” in step S952), the indicator control unit 215 displays the scan point 63 at a fixed position in the center of the relevant scannable object (step S953) and terminates the process. If the scanned object being aimed is of the indicator following type (“following type” in step S952), the indicator control unit 215 displays the scan point 63 at a position that follows the aiming cursor 62 that is aligned with the relevant scannable object (step S954) and terminates the process.

If the aiming is not aligned with any of the scannable objects (NO in step S951), the process ends as is.

Returning to FIG. 9A, the action control unit 216 determines whether a switching input to the shooting mode has been made (step S92). If it is determined that a switching input to the shooting mode has been made (YES in step S92), the process returns to step S91. If it is not determined that a switching input to shooting mode has been made (NO in step S92), and if it is not determined that a scan start input has been made (NO in step S93), the process returns to step S92.

If a scan instruction input by pressing the L button 118 is received (YES in step S93), the action control unit 216 starts scanning (step S94), and during the execution of scanning, the success of scanning is determined (step S95). The condition under which the scan is not successful (NO in step S95) may be, for example, that the scan is interrupted by an attack by an enemy character or the like, or that the user has made a certain input.

If the scan is successful (YES in step S95), the action control unit 216 displays an explanatory UI associated with the scanned object (step S96). The display of the explanatory UI may end, for example, after a certain period of time or based on an operation from the user. After displaying the explanatory UI, processing returns to step S92. For example, after displaying the explanatory UI, the system may automatically switch from the scanning mode to the shooting mode, and the process may return to step S91.

If the L button 118 is pressed while the aiming cursor 62 is not aligned with any scannable objects, the action control unit 216 does not consider that a valid scanning instruction has been received in step S93 (NO in step S93), scanning is not performed, and processing returns to step S92.

As described above, according to the information processing system of the embodiment, an indicator fixed type or indicator following type is set for multiple scannable objects in the virtual space, and for the scannable objects of the indicator following type, the position where the scan point as an indicator is displayed is moved according to the aiming direction, thus suppressing rapid changes in the direction of the virtual camera when the scanning instruction is given and the direction of the virtual camera and aiming direction are turned toward the indicator. This can suppress rapid changes in the game screen.

This can improve the user experience by allowing the player to clearly see the object being scanned when scanning a scannable object within the aiming direction in the scanning mode, and also by suppressing rapid changes in the game screen due to the scanning.

1. A computer-readable non-transitory storage medium, having stored therein instructions to be executed by one or more processors of an information processing apparatuses, the instructions when executed causing the one or more processors to at least:
in a first scene,
control a direction of a virtual camera in a virtual space based on directional input;
control an aiming direction in the virtual space based on directional input;
display an indicator at a first position that overlaps an object of a first type, when the object of the first type located in the virtual space is in the aiming direction;
display an indicator at a second position that is moved in accordance with the aiming direction within a range at least overlapping with an object of a second type that is located in the virtual space and is different from the object of the first type, when the object of the second type is in the aiming direction; and
direct the direction of the virtual camera and the aiming direction to the indicator in response to an operation input when the indicator is displayed.

2. The computer-readable non-transitory storage medium according to claim 1, wherein the instructions cause the one or more processors to:
control the direction of the virtual camera and the aiming direction to match based on the same directional input.

3. The computer-readable non-transitory storage medium according to claim 1, wherein the instructions further cause the one or more processors to:
display an aiming cursor indicating the aiming direction; and
display the indicator when the aiming direction is directed at the object of the first type or the object of the second type.

4. The computer-readable non-transitory storage medium according to claim 1, wherein the object of the second type is larger than the object of the first type.

5. The computer-readable non-transitory storage medium according to claim 1, wherein, the instructions further cause the one or more processors to:
display an explanatory UI associated with the object corresponding to the indicator in response to the operational input.

6. The computer-readable non-transitory storage medium according to claim 1, wherein, the instructions further cause the one or more processors to:
move a player character within the virtual space based on directional input; and
control a position of the virtual camera according to a position of the player character within the virtual space.

7. The computer-readable non-transitory storage medium according to claim 1, wherein, the instructions cause the one or more processors to:
in a second scene different from the first scene,
restrict the direction of the virtual camera in the virtual space;
control the aiming direction in the virtual space based on directional input; and
display an indicator at a first position that overlaps an object of a first type, when the object of the first type located in the virtual space is in the aiming direction;
display an indicator at a second position that is moved in accordance with the aiming direction within a range at least overlapping with an object of a second type that is placed in the virtual space and is different from the object of the first type, when the object of the second type is in the aiming direction;
direct the direction of the virtual camera and the aiming direction to the indicator in response to an operation input when the indicator is displayed.

8. An information processing system, comprising one or more processors and a memory coupled thereto, wherein the one or more processors are configured to control the information processing system to perform at least:
in a first scene,
controlling a direction of a virtual camera in a virtual space based on directional input;
controlling an aiming direction in the virtual space based on directional input;
displaying an indicator at a first position that overlaps an object of a first type, when the object of the first type located in the virtual space is in the aiming direction;
displaying an indicator at a second position that is moved in accordance with the aiming direction within a range at least overlapping with an object of a second type that is placed in the virtual space and is different from the object of the first type, when the object of the second type is in the aiming direction; and
directing the direction of the virtual camera and the aiming direction to the indicator in response to an operation input when the indicator is displayed.

9. An information processing apparatus, comprising one or more processors and a memory coupled thereto, wherein the one or more processors are configured to control the information processing apparatus to perform at least:
in a first scene,
controlling a direction of a virtual camera in a virtual space based on directional input;
controlling an aiming direction in the virtual space based on directional input;
displaying an indicator at a first position that overlaps an object of a first type, when the object of the first type, located in the virtual space is in the aiming direction;
displaying an indicator at a second position that is moved in accordance with the aiming direction within an range at least overlapping with an object of a second type that is placed in the virtual space and is different from the object of the first type, when the object of the second type is in the aiming direction; and
directing the direction of the virtual camera and the aiming direction to the indicator in response to an operation input when the indicator is displayed.

10. An information processing method executed using one or more processors, the information processing method comprising:
in a first scene,
controlling a direction of a virtual camera in a virtual space based on directional input;
controlling an aiming direction in the virtual space based on directional input;
displaying an indicator at a first position that overlaps an object of a first type, when the object of the first type, located in the virtual space is in the aiming direction;
displaying an indicator at a second position that is moved in accordance with the aiming direction within a range at least overlapping with an object of a second type that is placed in the virtual space and is different from the object of the first type, when the object of the second type is in the aiming direction; and
directing the direction of the virtual camera and the aiming direction to the indicator in response to an operation input when the indicator is displayed.
